(19) United States
(12) Patent Application Publication
(10) Pub. No.: US 2006/0229914 A1
(43) Pub. Date: Oct. 12, 2006

(54) Method of providing support for, and monitoring of, persons recovering from addictive behaviors, mental health issues, and chronic health concerns

(76) Inventor: Ronald K. Armstrong II, Pacific Palisades, CA (US)

Correspondence Address: CISLO & THOMAS, LLP, 233 WILSHIRE BLVD, SUITE 900, SANTA MONICA, CA, 90401-1211, US

(21) Appl. No.: 11/403,728

(22) Filed: Apr. 12, 2006

Related U.S. Application Data
(60) Provisional application No. 60/670,818, filed on Apr. 12, 2005.

(51) Int. Cl. G06Q 10/00

(52) U.S. Cl. 705/2

(57) ABSTRACT

A method of providing support for, and monitoring of, an individual recovering from addictive behaviors, mental health issues, or other chronic health concerns comprises a multi-tiered support system for the recovering individual and monitoring the recovering individual's commitment to recovery. The basic set of activities that may be integrated into a program include: (1) periodic review sessions with a program monitor; (2) attendance at Twelve-Step meetings; (3) daily online activity reporting; (4) online educational assignments; (5) community service commitments; (6) a recreational activity undertaken by the individual; and, (7) drug and/or biological fluid testing where applicable. The daily online activity reporting feature allows for support to be provided for a person seeking support services. If the person fails to engage in the daily activity reporting, an alert notification can be triggered to allow doctors, treatment providers, friends, and/or family to provide needed support for, and increase the accountability of, the person receiving support services.

### CROSS-REFERENCES TO RELATED APPLICATIONS

This patent application claims the benefit of U.S. Patent Provisional Application Ser. No. 60/670,818, filed Apr. 12, 2005, for Method of Providing Support For, and Monitoring of, Persons Recovering from Addictive Behaviors, which application is incorporated herein by this reference.

### TECHNICAL FIELD

This invention relates to a method of providing support for, and monitoring of, persons seeking relief from alcoholism, drug addiction, or other addictive behaviors, as well as mental health issues including depression, phobias, and anxiety, and chronic health concerns that can benefit from long-term monitoring such as diabetes care and pain management.

### BACKGROUND ART

The toll that addictions such as drug and alcohol addiction take on persons, families, companies, states, and nations is well documented. This toll is biological, psychological, spiritual, sociological, as well as financial. That is, persons who suffer from drug, alcohol, or other addictions suffer psychologically and physically and may suffer further as a result of loss of employment and estrangement from friends, family, and community because of the addiction. Family members and friends of persons who suffer from drug, alcohol, or other addictions also suffer from observing the dire circumstances of the addict, by bearing the brunt of the addict's unstable behavior, and may also suffer financially in attempting to help the addict. A company where an addict is employed may suffer in ways similar to the addict's family or friends, but also by the addict's decreased productivity on the job, impaired judgment, absenteeism, and workplace injuries. States and nations suffer from drug, alcohol, and other addictions in terms of increased crime and the astronomical healthcare and legal costs for rehabilitating or incarcerating addicts. Drug addiction, alcoholism, and other addictions (such as gambling) are major issues present throughout the world, and a means for effective and lasting treatment of these and other addictions is necessary for the benefit of all levels of society. The problem of addiction is therefore systemic; as such, it requires a systemic solution.

To combat the ever-increasing toll that drug, alcohol, and other addictions take on the United States and many other countries, many different methods of addiction treatment have been undertaken. Inpatient rehabilitation programs such as the Betty Ford Center® and Hazelden® exist, as do outpatient rehabilitation programs and rapid detoxification programs. One shortcoming of such treatment programs is that they offer only temporary support, and once outside of the sheltered environment of a treatment facility or detox program, there is little to prevent a drug addict, alcoholic, or other type of addict from relapsing to the causes and conditions that drive addictive behavior in the first place.

Some persons who complete a short-term rehabilitation program may attempt to maintain their abstinence by willpower. Other persons may commence individualized psychological or psychotherapeutic treatment. Still others may attend Twelve Step meetings such as Alcoholics Anonymous®. While each of these endeavors may, in some cases, be effective in and of themselves to allow a person to maintain abstinence from a particular addiction, there still exists a high probability of relapse to addiction as evidenced by the same person making repeat visits to a treatment program, or falling back into criminal activity as a result of relapsing to the addictive behavior.

The present invention provides an interactive, comprehensive, and individualized method of support for, and monitoring of, an individual's recovery process by which a person completing a stay at a rehabilitation program; a person released from prison or otherwise ordered by a court, government agency, professional organization, union, or other lawfully-entitled entity; or a self-referred person can retain a recovery support services entity to oversee an individual's recovery process for an extended period of time. The invention can provide not only an individual with a structured, multi-tiered support system that enhances the individual's prospects for maintaining abstinence from his or her addictive or compulsive behavior, but also support for those persons close to the individual such as friends, family, co-workers, and employers.

The present invention can also be used as a system for providing support for other long-term conditions that can benefit from monitoring, such as diabetes and pain management treatment processes.

### DISCLOSURE OF INVENTION

In view of the foregoing disadvantages in the known types of methods of recovering from alcoholism or drug addiction, the present invention provides a novel, integrated method wherein an individual's recovery from alcoholism, drug addiction, or other addictive behaviors can be supported and monitored, in large part, over a secure Internet website or remotely accessible server operated by an entity providing the program of recovery support, and by authorized individuals such as a program monitor, representatives of the entity providing the program of recovery support, family members, friends, treatment providers, and other health care providers. The invention disclosed herein may also be adapted to provide support for, and monitoring of, other chronic health concerns such as pain management and diabetes care.

The method described herein is designed to provide an individualized, multidimensional support program that takes into account each person's unique situation at their point of entry into the program. The basic structure of the program includes an array of daily educational and experiential activities selected for the individual, a tiered support network developed for each individual, and multiple systems for monitoring individual behavior. The basic set of activities that can be integrated into each program include: (1) periodic review sessions with a program monitor; (2) attendance at Twelve-Step meetings; (3) daily online journaling or activity reporting; (4) online educational assignments; (5) one or more community service commitments; (6) a recreational and/or hobby activity to be undertaken by the individual; and, (7) drug and/or biological fluid testing where applicable. The daily online journaling or activity reporting feature is a critical element in allowing for support to be provided for a person seeking to maintain abstinence from an addictive behavior, to overcome a compulsive behavior, or to maintain compliance with other programs regarding chronic health concerns. If an individual fails to engage in the daily activity reporting, an alert notification can be triggered to allow doctors, treatment providers, friends, and/or family to provide needed support for and increase the accountability of the person receiving support services. Even if compliance is occurring, a review of the journaling or activity reports by the program monitor may indicate that the individual is in danger of relapse. This may allow the entity providing support services or the program monitor to intervene and stabilize the situation, including mobilizing support from others.

It is an object of the present invention to provide a method of offering individuals seeking to recover from alcoholism, drug addiction, or other addictive behaviors, as well as mental health issues including depression, phobias, and anxiety, and chronic health concerns that can benefit from long-term monitoring such as diabetes care and pain management, an innovative and integrated system of support that facilitates the process of one's reconnection with self, family, workplace, and community.

It is another object of the present invention to provide a novel, integrated method wherein an individual's recovery from alcoholism, drug addiction, or other addictive behaviors can be supported and monitored, in large part, over a secure Internet website or remotely accessible server operated by an entity providing the program of recovery support, and by authorized individuals such as a program monitor, representatives of the entity providing the program of recovery support, family members, friends, treatment providers, and other health care providers.

These and other objects and advantages of the present invention will be apparent from a review of this specification and the accompanying figures.

### BRIEF DESCRIPTION OF DRAWINGS

FIG. 1 is a schematic of an embodiment of a method in accordance with the present invention.

FIG. 2 is a schematic of an embodiment of a method in accordance with the present invention.

FIG. 3 is a schematic of an embodiment of a method in accordance with the present invention.

FIG. 4 is a schematic of a family support component of an embodiment of the invention.

FIG. 5 is a schematic of a workplace support component of an embodiment of the invention.

FIGS. 6A and 6B show a daily activity report and educational prompt in accordance with an embodiment of the present invention.

FIG. 7 is a view of a calendar in accordance with an embodiment of the present invention.

FIG. 8 is a view of a message board in accordance with an embodiment of the present invention.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

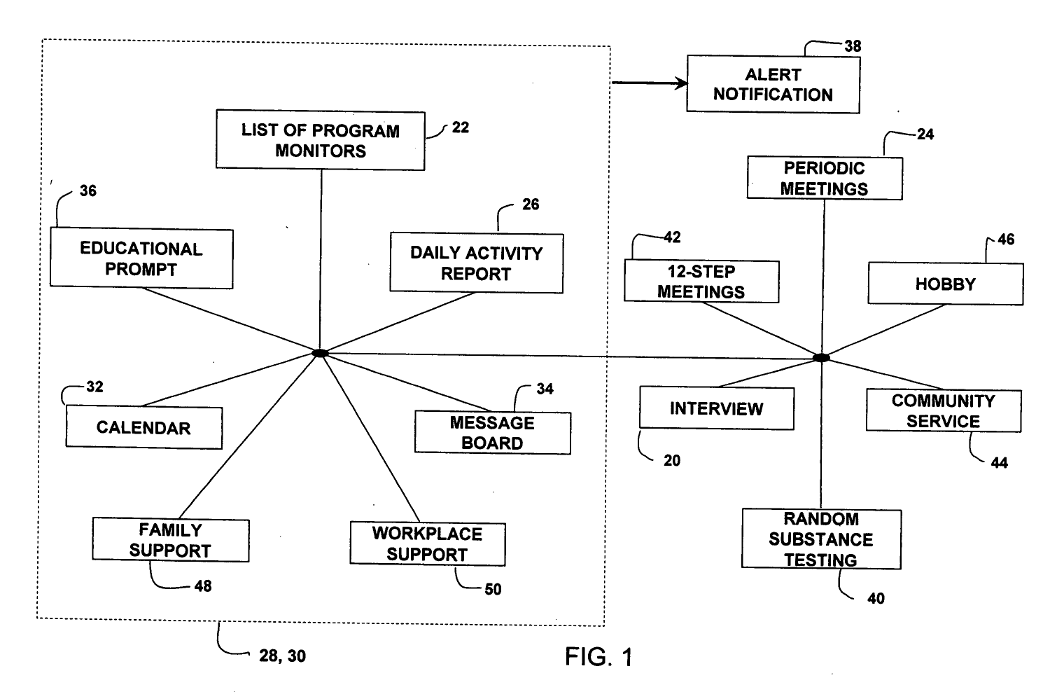

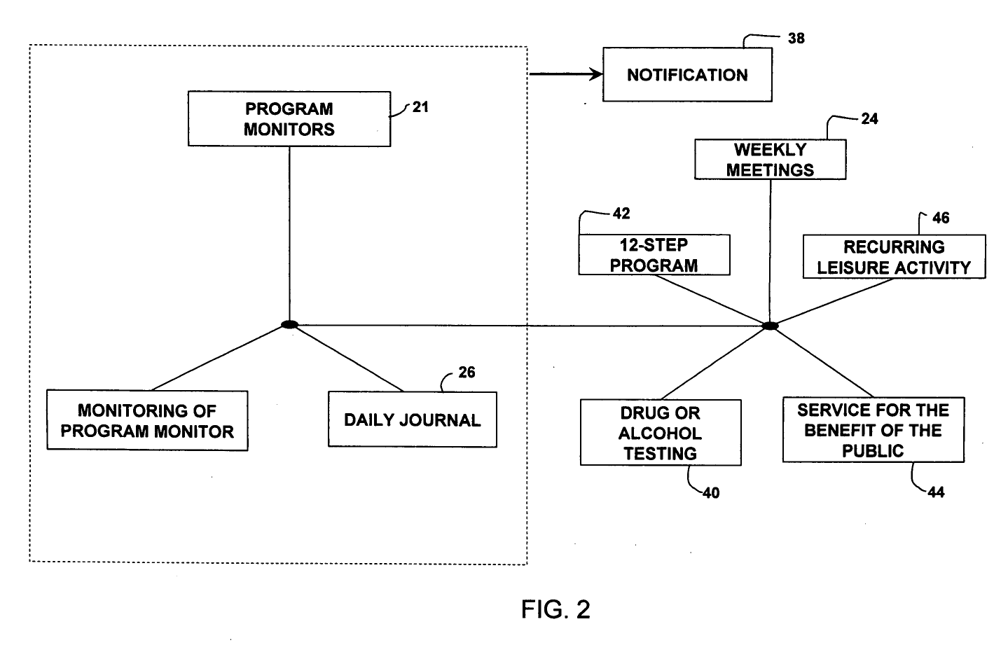

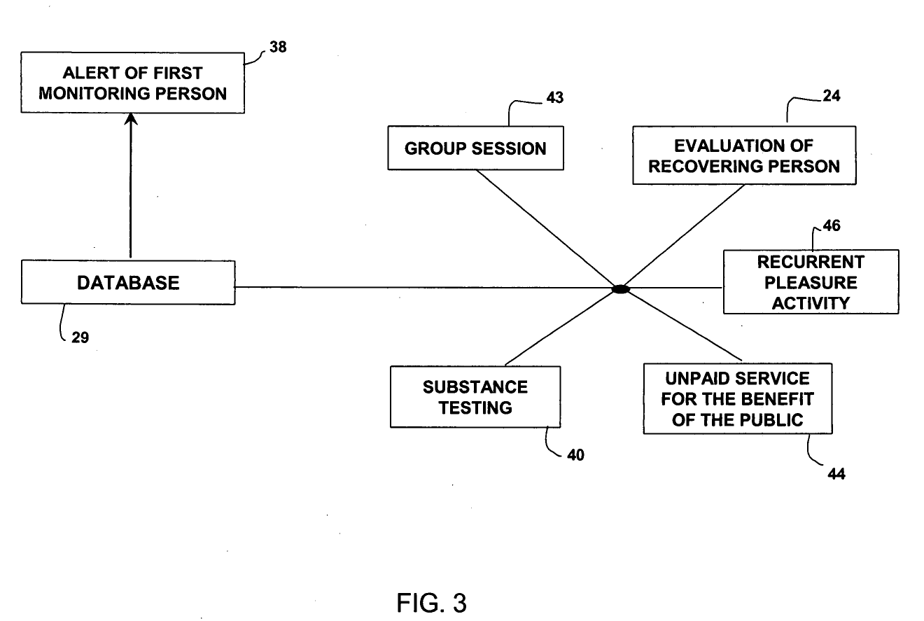

The method of providing support for, and monitoring of, persons recovering from addictive behaviors is an innovative, integrated, customized program providing twenty-four hour, international access to support for, and monitoring of, individuals recovering from alcoholism, drug addiction, other addictive behaviors, and compulsive behaviors, as well as mental health issues including depression, phobias, and anxiety, and chronic health concerns that can benefit from long-term monitoring such as diabetes care and pain management. Sample embodiments of the invention are depicted in FIGS. 1-3.

Referring to the figures, in a preferred embodiment, the program includes an interview 20 with a representative of an entity that oversees the program or another designated person who will assess the particular needs of the individual seeking support services for alcoholism, drug addiction, or other addictive behaviors or chronic health concerns. The specific process for enrolling in the program depends on whether the person is (a) currently in residential treatment, (b) signs up as part of a family or workplace intervention, (c) mandated by a health care professional, or (d) makes the decision independently.

One element of the program that the interview is effective in determining is the duration of time that a particular individual should remain in the program, although the duration of the program is open-ended and can be extended indefinitely.

By way of example, for individuals who have been discharged from a residential treatment program, it is preferred that such persons undertake at least a 180-day commitment. For self-referring individuals who are using the program as a preventative measure and support system, it is preferred that such persons undertake a 6-month commitment. In situation where the individual's commitment is mandated by third parties such as a court, an employer, a diversion program, health care providers, or family members, commitment may be open-ended as directed by the third party.

Once an individual is enrolled in the program, in one embodiment, the individual is required to select a program monitor 21 who is typically a counselor or therapist with training in helping those with addictive, compulsive, or other behavioral or health issues, not necessarily employed by, or directly affiliated with the entity providing the program of recovery support. A list of pre-screened program monitors 22 approved by the entity offering the program may be provided to each program participant. The individual may then interview potential program monitors and select one to meet with periodically for the duration of the program. It is preferred that these periodic meetings 24 occur weekly, although more or less frequent meetings are within the spirit of the invention described herein. The program monitors 21 are themselves monitored by representatives of the entity providing the program of recovery support to ensure the program monitor's compliance with his or her obligations and duties.

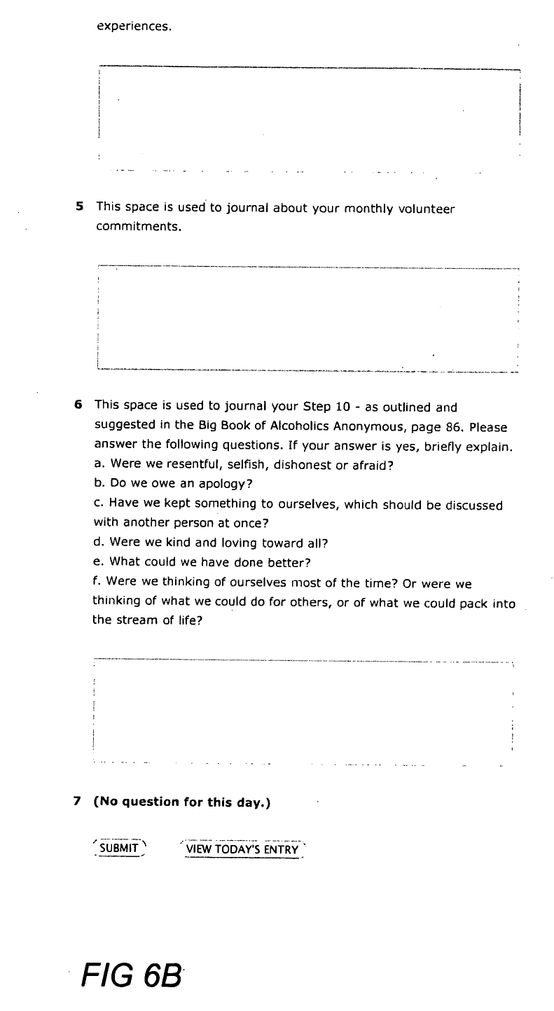

Prior to the periodic meetings 24, the program monitor 21 is obligated to review the online journaling work or daily activity report 26 of the individual. An example of a daily activity report 26 is shown in FIG. 6. During the periodic meetings 24 between the program monitor 21 and the individual enrolled in the program, the program monitor 21 reinforces the work being done by the individual, may comment on such work, may provide guidance and direction to the individual, and generally serves to facilitate or enhance accountability on the part of the enrolled individual. The program monitor 21 thus provides evaluation of the recovering person.

In another embodiment, the program monitor 21 or representatives of the entity providing the program of recovery support may conduct such periodic meetings 24 via videoconference or similar technology such that remote, but live, “face-to-face” meetings can occur between the program monitor 21 or representatives of the entity providing the program of recovery support and the individual enrolled in the program. Such technology permits interaction between the individual and a representative of the entity providing the program of recovery support although neither are in the same location.

The Internet website 28 or the remotely accessible server 30 plays a role in the individual's compliance with the program and the ability of authorized third parties to provide support for, and monitor, the enrolled individual's recovery process. The present invention utilizes a secure Internet website 28 or remotely accessible server 30, built and maintained by procedures well known in the art, and operated by the entity providing the program of recovery support. The remotely accessible server 30 might be accessed by, for example, a personal digital assistant, telephone, wireless telephone, personal computer, email device, wireless data message device, voice recognition technology, and/or Blackberry® device. Additionally, the Internet website 28 and/or the remotely accessible server 30 may be associated with a database 29.

There are at least three ways in which the Internet website 28 or the remotely accessible server 30 is an important aspect of the program.

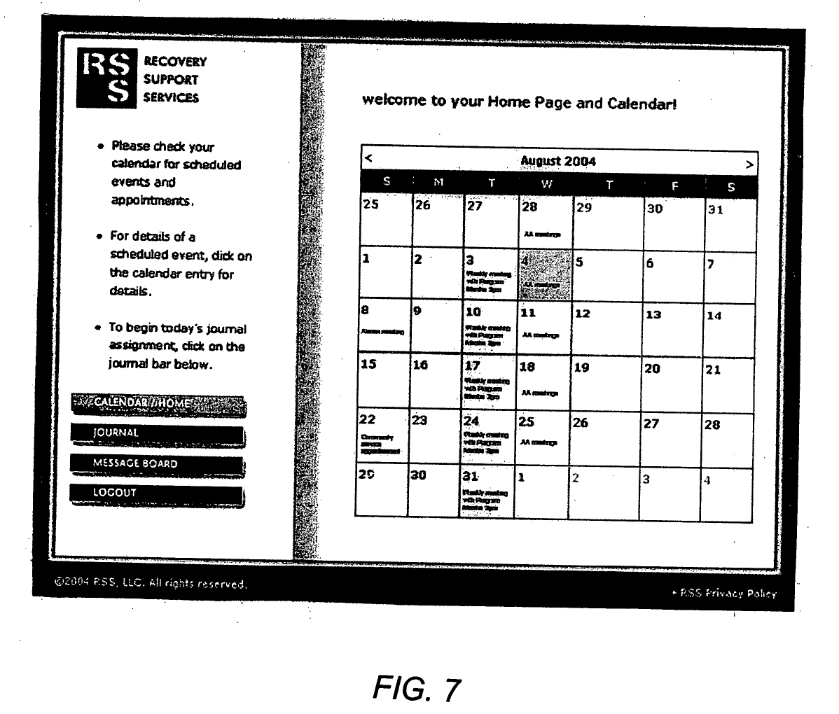

First, an electronic calendar 32 is accessible via the Internet website 28 or through the remotely accessible server 30 to the enrolled individual and authorized third parties (including, but not limited to, the program monitor 21, representatives of the entity providing the program of recovery support, and/or friends and family members of the enrolled individual) where scheduled events and appointments are listed, along with details of time and location of the events and appointments. An example of the calendar 32 is shown by FIG. 7.

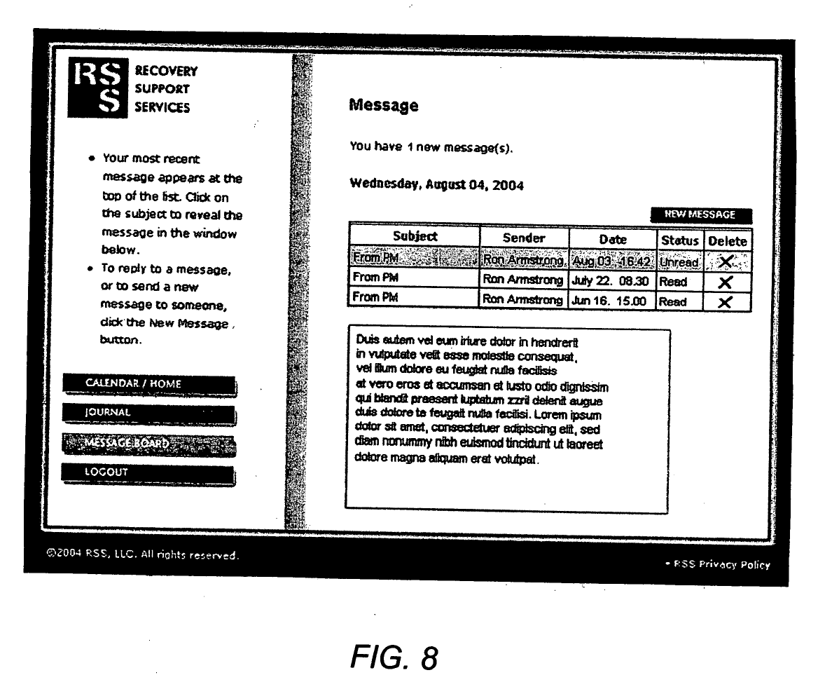

Second, a personal message board 34, accessible via the Internet website 28 or through the remotely accessible server 30, is provided for secure communication between the enrolled individual and representatives of the entity providing the program of recovery support, the program monitor 21, friends, family, and/or other authorized persons who support the recovery process. An example of the message board 34 is shown by FIG. 8.

Third, an online daily journal page or daily activity report 26 is provided for the enrolled individual to reflect on thought-provoking questions raised by a Thought for the Day, meditation text, or other prompt or cue provided by the representatives of the entity providing the program of recovery support, to write educational workbook assignments in response to an educational prompt 36, or to record others thoughts and feelings. Refer also to FIG. 6A and FIG. 6B. It is also contemplated that the daily journal page or daily activity report 26 may comprise any data collection capability beyond the entry of text, such as recording the individual's voice, heart rate, breathing rate, global position, or other such data, whether transmitted to the daily journal page or daily activity report 26 remotely (for example, by a device worn by the individual) or entered via the Internet website 28 or remotely accessible server 30.

Daily activity reporting and educational writing assignments are an essential part of the recovery support program and are designed to encourage thought and reflection, and allow for monitoring of the activities of the enrolled person's individually designed program. Completing the assignments is an indication of the enrolled individual's ongoing commitment to recovery and/or compliance with programs directed to other chronic health concerns. The content of the daily activity reporting and educational writing assignments are available over a secure Internet website 28 or through a remotely accessible server 30 to the enrolled individual and representatives of the entity providing the program of recovery support, the program monitor 21, friends, family, and/or other authorized persons who monitor and support the recovery process.

A novel and important element of the present invention is an alert notification 38 wherein a first monitoring person, being authorized individuals such as the program monitor 21, representatives of the entity providing the program of recovery support, family members, friends, treatment providers, and/or other health care providers, are immediately and automatically notified when an enrolled individual has not completed a daily writing assignment, journaling task, or activity report. This represents an important aspect of both the support and monitoring of enrolled individuals who, in early stages of abstinence from their particular addictive behavior may be quite susceptible to relapse, which could be potentially dangerous or fatal to the enrolled individual and others. This is also an effective method of monitoring a patient's compliance with, and success with, programs regarding chronic health concerns. This notification may be in the form of an email, text message, instant message, voicemail, telephone call, or other notice to the authorized person or to a communication device of the authorized person. The communication device might be a personal digital assistant, wireless telephone, personal computer, email device, wireless data message device, and/or Blackberry® device.

Another aspect of monitoring the enrolled individual in the case of recovery from substance abuse is provided for by substance testing in the form of random biological fluid or tissue testing 40 administered by representatives of the entity providing the program of recovery support or other authorized personnel. Entry into the program may require the consent of the individual to such random biological fluid and tissue testing 40. In the event that an addictive behavior does not involve ingestion of intoxicating substances or other materials (such as for gambling), this aspect can be omitted.

A third aspect of monitoring the enrolled individual is provided for by the periodic meetings 24 between the enrolled individual and a second monitoring person, being the program monitor 21 or representatives of the entity providing the program of recovery support, as described above.

Another feature of the present invention as it pertains to recovery from addictive and/or compulsive behaviors, which provides a comprehensive, integrated program of recovery support, is a requirement that the enrolled individual attend regular twelve-step meetings 42 such as Alcoholics Anonymous®, or other similar group sessions 43 based on the twelve steps of Alcoholics Anonymous@. Such meetings 42 generally involve a spiritually oriented program of recovery from addiction.

Twelve-step programs, such as Alcoholics Anonymous®, have had a long and successful history. Recent scientific research adds great credibility to the positive reports of the members of Alcoholics Anonymous®. In studies measuring the effectiveness of twelve-step programs used in conjunction with other therapies or alone, the programs were seen to have a positive effect on maintaining behavior change, especially when total abstinence was a goal. The invention described herein embraces the philosophy and methodology of the twelve-step process and participation and attendance in such twelve-step group meetings is a requirement of the program described herein. The enrolled individual's attendance at such meetings can be monitored by authorized individuals, such as the program monitor 21, representatives of the entity providing the program of recovery support, family members, friends, treatment providers, and/or other health care providers, via the calendar or daily activity report 26 on a secure Internet website 28 or through a remotely accessible server 30, operated by the entity providing the program of recovery support.

Another step in the present invention urges the enrolled individual to participate in community service activities 44, which involve service for the benefit of the public that is generally unpaid. Addiction robs the larger community of its citizens by diverting their attention from the society in which they live to their self-serving obsession. Performing community service 44 is one way in which enrolled individuals can see firsthand the effects of their addictive behaviors on individuals and society, while working to restore what their addiction has taken away. In addition, the enrolled individual's participation in community service activities 44 may serve a deterrent function by revealing to the enrolled individual the damage and injury caused by his or her addictive behaviors. Involvement in community service 44 also tends to produce self-esteem in individuals, which is often lacking in individuals beginning their recovery from addictive behaviors.

Another aspect of the present invention strongly suggests that the enrolled individual either take up a hobby 46 or recreational activity or rediscover a hobby or recreational activity once enjoyed. Participation in a hobby 46 or recreational activity is beneficial to a person attempting to recover from addiction in that it occupies time on that person's calendar that might otherwise be spent engaging in the addictive behavior. In addition, participation is a hobby 46 or recreational activity, often engaged in primarily for pleasure, promotes health and self-esteem, as well, which are beneficial to the recovery process. Recurrent leisure activities such as a hobby 46 or recreational activity, in certain embodiments, may be a requirement of the program of recovery support.

As discussed above, the invention described herein contains an educational component in response to an educational prompt 36. Enrolled individuals may utilize workbooks that introduce various topics relating to addiction and recovery, such as physical wellness, anger management, problem-solving, and nutrition. As stated above, completing daily workbook assignments not only demonstrates an enrolled individual's commitment to recovery, which can be monitored as described above, but it also increases the enrolled individual's understanding and awareness of all aspects of the recovery process.

Another step in the present invention provides for family support 48 of the individual enrolled in the program of recovery or support. Addiction manifests itself in a systemic way, affecting everyone, to varying degrees, in the addicted person's family, as well as in their social and workplace environments. One important feature of the program described herein is to create a collective recovery experience for all concerned. Because the family as a whole is affected by the addiction, it is important to allow the individual members of the family to recover together whenever possible. When families are included in the recovery process, they are often a powerful force in keeping the enrolled individual accountable. In the unfortunate case of a relapse, a family that is part of the overall recovery process is in a much better position to respond appropriately. In one embodiment of the present invention, the entity providing the program of recovery support assists family members in gaining the resources to help stabilize and support themselves while supporting the enrolled individual.

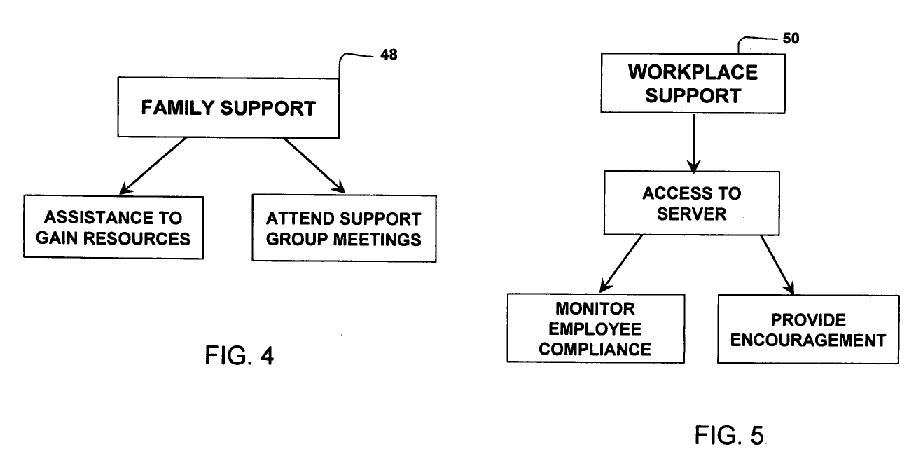

As part of the family support component 48, it may be recommended that family members and friends of the enrolled individual attend meetings of Al-Anon®, or another support group for family and friends of those with addictive or compulsive behaviors. An example of the family support component 48 is shown by FIG. 4.

Substance abuse and other addictive behaviors can have a detrimental effect in the workplace. In situations in which an employer requires an employee attempting to recover from addictive or compulsive behavior(s) to enroll in the recovery support program, the present invention, in certain embodiments, provides for workplace support 50. In such cases, the employer (or representatives of the employer) are designated as authorized persons who are able to access a secure Internet website 28 or a remotely accessible server 30 for the particular employee enrolled in the program, thereby allowing the employer to monitor compliance with the program, as well as providing support and encouragement for the employee where needed. In other respects, the program, in a situation where an employer required an employee to enroll in the program, functions as described herein.

In one embodiment of the present invention, it is understood that an employer can implement the present invention within the company or similar entity such that the company itself would serve as the entity that oversees the program described herein.

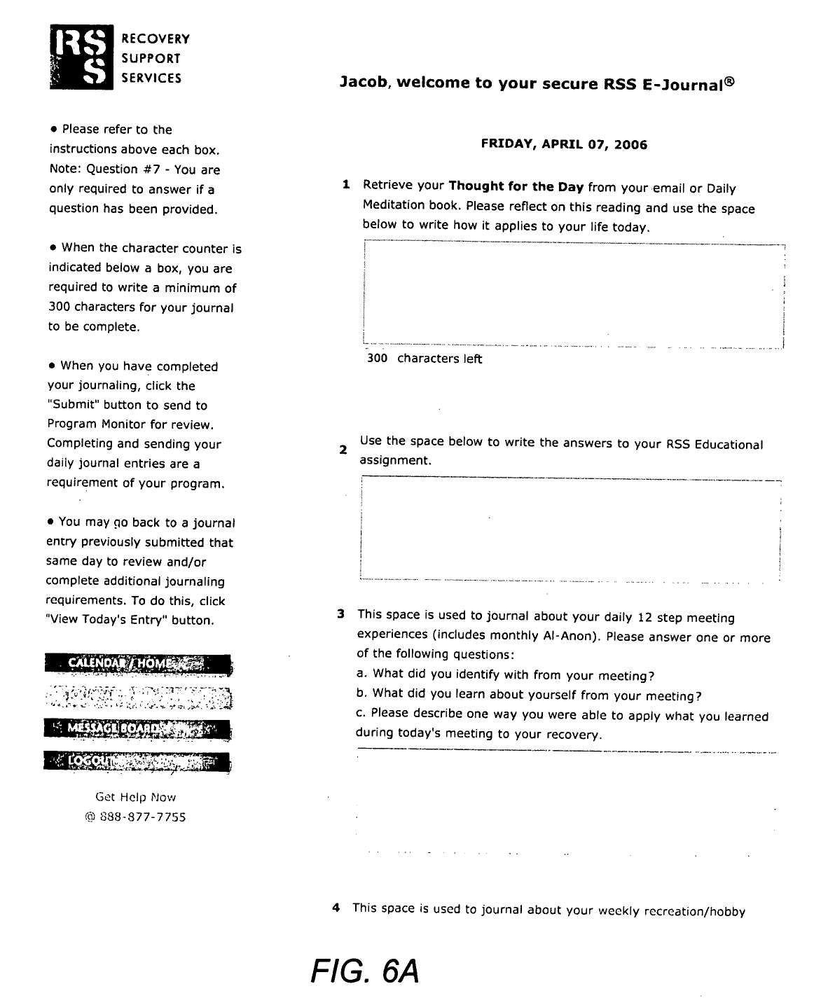

In another embodiment of the present invention, it is also understood that an entity that provides short-term treatment for individuals suffering from particular addictions (i.e., a rehabilitation facility) could implement the present invention to monitor individuals who complete the short-term rehabilitation programs, thus serving as the entity that oversees the program described herein. An example of the workplace support component 50 is shown by FIG. 5.

As stated herein, a portion of the method described herein utilizes an Internet website 28 or a remotely accessible server 30 for supporting and monitoring an enrolled individual. As such, the present invention is available and accessible for use twenty-four hours a day from anywhere in the world. As further stated herein, in one embodiment of the present invention, the required periodic meetings 24 between the enrolled individual and the program monitor 21 or representatives of the entity providing the program of recovery support may occur via videoconferencing technology. This embodiment further supports a recovery support service that can be provided throughout the world.

While the present invention has been described with regards to particular embodiments, it is recognized that additional variations of the present invention may be devised without departing from the inventive concept.

### INDUSTRIAL APPLICABILITY

The present invention may be applied to methods of providing support for, and monitoring of, persons recovering from alcoholism, drug addiction, or other addictive behaviors, as well as mental health issues including depression, phobias, and anxiety, and chronic health concerns that can benefit from long-term monitoring such as diabetes care and pain management.

What is claimed is:

1. A method of providing support services to an individual for an addictive behavior, comprising:
(a) interviewing an individual seeking to maintain abstinence from a particular addiction by a representative of an entity providing a recovery support program;
(b) providing a list of approved program monitors from which the individual receiving support services selects a program monitor;
(c) providing an Internet website having a daily activity report and an educational prompt, the daily activity report requiring a minimum entry by the individual receiving support services after reflection upon thought-provoking statements provided to the individual, the educational prompt requiring a minimum entry by the individual receiving support services in response to the prompt, the website requiring an access code;
(d) obligating the individual receiving support services to complete the daily activity report;
(e) reviewing by the program monitor on a regular basis the daily activity report and the response to the educational prompt of the individual receiving support services;
(f) requiring regular meeting sessions between the program monitor and the individual receiving support services;
(g) auditing the program monitor by the entity providing recovery support;
(h) providing an alert notification, where at least one authorized individual is automatically notified when the individual receiving support services has not completed the daily activity report or the response to the educational prompt;
(i) providing random biological testing of the fluids or tissues of the individual receiving support services;
(j) requiring the individual receiving support services to attend twelve-step meetings; and
(k) requiring the individual receiving support services to participate in community service activities.

2. The method of claim 1 further comprising providing workplace support for the individual receiving support services by permitting the employer of the individual receiving support services to access the Internet website to monitor the individual's compliance to the support services.

3. The method of claim 1 wherein the Internet website further has an electronic calendar, the electronic calendar listing times and places for the activities of the individual receiving support services.

4. The method of claim 1 further comprising providing family support for the individual receiving support services by permitting at least one family member of the individual receiving support services to access the Internet website to monitor the individual's compliance to the support services.

5. The method of claim 1 wherein the Internet website further has a personal message board permitting communication between the individual receiving support services and at least one authorized individual.

6. The method of claim 5 further comprising providing workplace support for the individual receiving support services by permitting the employer of the individual receiving support services to access the Internet website to monitor the individual's compliance to the support services.

7. The method of claim 5 further comprising providing family support for the individual receiving support services by permitting at least one family member of the individual receiving support services to access the Internet website to monitor the individual's compliance to the support services.

8. The method of claim 1 wherein a representative of the entity providing recovery support suggests that the individual receiving support services take up a hobby or recreational activity.

9. The method of claim 1 further comprising providing family support for the individual receiving support services by recommending family members and friends of the individual receiving support services attend meetings of a support group for family members or friends of those with addiction and by assisting the family members to gain the resources to support themselves while supporting the individual receiving support services.

10. The method of claim 1 wherein the weekly meeting sessions take place by videoconference.

11. The method of claim 10 further comprising providing workplace support for the individual receiving support services by permitting the employer of the individual receiving support services to access the Internet website to monitor the individual's compliance to the support services.

12. The method of claim 10 further comprising providing family support for the individual receiving support services by permitting at least one family member of the individual receiving support services to access the Internet website to monitor the individual's compliance to the support services.

13. A method of providing support services to an enrolled individual for an addiction, comprising:
(a) providing a server that can be remotely accessed, the server permitting entry of data to a daily report by the enrolled individual;
(b) requiring a minimum entry of data to the daily report by the enrolled individual; and
(c) providing a notification to at least one predetermined person when the enrolled individual has not satisfied the minimum entry of data to the daily report.

14. The method of claim 13 wherein the remote access to the server is via the Internet.

15. The method of claim 13 further comprising providing workplace support for the enrolled individual by permitting an employer of the enrolled individual to access the Internet website to monitor the individual's compliance to the support services.

16. The method of claim 13 further comprising assisting the family of the enrolled individual to gain resources to support the family during the support services of the enrolled individual.

17. The method of claim 13 further comprising providing family support for the individual receiving support services by permitting at least one family member of the enrolled individual to access the server to monitor the individual's compliance to the support services.

18. The method of claim 13 further comprising:
(a) assigning a program monitor to the enrolled individual, the program monitor having specified duties, the specified duties comprising regular meetings with the enrolled individual;
(b) monitoring the program monitor to determine compliance with his or her duties;
(c) advocating participation by the enrolled individual in a twelve-step program;
(d) encouraging involvement by the enrolled individual with a service for the benefit of the public;
(e) supporting involvement by the enrolled individual in a recurring leisure activity; and
(f) providing drug or alcohol testing for the enrolled individual.

19. The method of claim 18 wherein the specified duties of the program monitor further comprise reviewing the daily report entries of the enrolled individual.

20. The method of claim 18 wherein the remote access to the server is via the Internet.

21. The method of claim 20 further comprising providing workplace support for the enrolled individual by permitting an employer of the enrolled individual to access the Internet website to monitor the individual's compliance to the support services.

22. The method of claim 18 further comprising assisting the family of the enrolled individual to gain resources to support the family during the support services of the enrolled individual.

23. The method of claim 18 further comprising permitting at least one authorized individual to access the server to monitor the individual's compliance to the support services.

24. The method of claim 18 wherein the daily report further comprises a thought-provoking prompt for the enrolled individual.

25. The method of claim 18 wherein the daily report further comprises an educational task to be addressed by the enrolled individual.

26. The method of claim 18 wherein the program monitor's regular meetings with the enrolled individual occur remotely.

27. The method of claim 23 wherein the at least one authorized individual is selected from the group consisting of:
(a) the program monitor,
(b) representatives of an entity providing the program of recovery support,
(c) family members,
(d) friends,
(e) treatment providers, and
(f) health care providers.

28. A method of assisting a person to recover from a compulsive behavior, comprising:
(a) providing a database and allowing remote user interface to the database;
(b) requiring the recovering person to enter data in the database at a predetermined interval;
(c) alerting at least one first monitoring person when the recovering person has not entered data in the database at the predetermined interval;
(d) requiring participation by the recovering person in group sessions based on a twelve-steps-to-recovery philosophy;
(e) suggesting involvement by the recovering person in unpaid service for the benefit of the public;
(f) encouraging the recovering person to engage in a recurrent activity that is primarily for pleasure; and
(g) requiring periodic evaluation of the recovering person by a second monitoring person, wherein the second monitoring person and the at least one first monitoring person could be the same person.

29. The method of claim 28 wherein the alert is transmitted in the manner selected from the group consisting of:
(a) sending an email message to the at least one first monitoring person,
(b) sending an instant message to the at least one first monitoring person,
(c) sending a text message to a personal communication device of the at least one first monitoring person,
(d) sending a recorded voicemail for the at least one first monitoring person, and
(e) placing a telephone call to the at least one first monitoring person.

30. The method of claim 28 further comprising providing testing for particular substances present within the system of the recovering person.

31. The method of claim 28 wherein the periodic evaluation of the recovering person comprises regular meetings between the recovering person and the second monitoring person.

32. The method of claim 28 further comprising permitting at least one authorized individual to access the database to monitor the recovering person's compliance to the assistance.

33. A method of providing support services to an individual suffering from a chronic health condition, comprising:
(a) providing a server that can be remotely accessed, the server permitting entry of data to a daily journal by the individual;
(b) requiring a minimum entry of data to the daily journal by the individual; and
(c) providing a notification to at least one predetermined person when the individual has not satisfied the minimum entry of data to the daily journal.

34. The method of claim 33 further comprising permitting at least one authorized individual to access the server to monitor the individual's compliance to the support services.

35. The method of claim 33 further comprising assisting the family of the individual to gain resources to support the family during the support services of the individual.

36. The method of claim 33 further comprising:
(a) assigning a monitor to the individual, the monitor having specified duties comprising regular meetings with the individual; and
(b) monitoring the monitor to determine compliance with his or her duties.

37. The method of claim 36 further comprising permitting at least one authorized individual to access the server to monitor the individual's compliance to the support services, the at least one authorized individual being selected from the group consisting of:
(a) the program monitor,
(b) representatives of an entity providing the program of recovery support,
(c) family members,
(d) friends,
(e) treatment providers, and
(f) health care providers.

38. The method of claim 36 further comprising assisting the family of the individual to gain resources to support the family during the support services of the individual.
